(19) United States
(12) Patent Application Publication
(10) Pub. No.: US 2021/0336715 A1
(43) Pub. Date: Oct. 28, 2021

(54) OPTICAL TRANSMITTING AND RECEIVING SYSTEM

(71) Applicant: ELECTRONICS AND TELECOMMUNICATIONS RESEARCH INSTITUTE, Daejeon (KR)

(72) Inventors: Eon-Sang KIM, Daejeon (KR); Joonyoung KIM, Daejeon (KR); Minkyu SUNG, Seoul (KR); Jong Hyun LEE, Daejeon (KR); Seung-Hyun CHO, Sejong-si (KR)

(21) Appl. No.: 17/230,143

(22) Filed: Apr. 14, 2021

(30) Foreign Application Priority Data
Apr. 22, 2020 (KR) 10-2020-0048846

(51) Int. Cl. H04J 14/02; H04B 10/40

(52) U.S. Cl. CPC H04J 14/0267; H04B 10/40; H04J 14/0239; H04J 14/028

(57) ABSTRACT

Provided is an optical transmitting and receiving system. The optical transmitting and receiving system may include: a Main Hub Unit (MHU) configured to perform wavelength division multiplexing on a plurality of downlink signals using a plurality of wavelengths and transmit the multiplexed downlink signal through a first optical cable; a first Remote Optical Unit (ROU) configured to perform demultiplexing on the multiplexed downlink signal received from the MHU and output a part of the plurality of downlink signals; and a second ROU configured to perform demultiplexing on the multiplexed downlink signal and output other part of the plurality of downlink signals.

### CROSS-REFERENCE TO RELATED APPLICATION

This application claims priority to and the benefit of Korean Patent Application No. 10-2020-0048846 filed in the Korean Intellectual Property Office on Apr. 22, 2020, the entire content of which is incorporated herein by reference.

### BACKGROUND OF THE DISCLOSURE

### 1. Field of the Disclosure

The present disclosure relates to an optical transmitting and receiving system and method.

### 2. Description of Related Art

As 5G wireless mobile communication services are commercially available, various wireless services and applications are emerging. Due to services such as Internet of Things (IoT), Virtual Reality (VR), Augmented Reality (AR), tactile Internet, and Connected Car (V2X), mobile communication systems and networks are evolving in the direction of not only large-scale real-time mobile data traffic transmission, but also low-latency transmission, massive connectivity and so on.

Accordingly, Indoor Distributed Antenna System (Indoor DAS), which is widely used to provide large-capacity wireless services without shadow areas in indoor environments, is drawing attention, and the amount of mobile data traffic consumed in densely populated indoor environments such as buildings is also rising rapidly. Meanwhile, for the construction and operation of an economical distributed antenna system, the importance of an analog Radio-over-Fiber (RoF) based transmission technology that optically transmits an intermediate frequency-based analog signal without converting a mobile signal into a digital signal is increasing.

In order to transmit a large-capacity amount of wireless data traffic, an indoor distributed antenna system of an analog RoF-based optical transmission method capable of wireless transmission of Multiple Input Multiple Output (MIMO) signals is required.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to provide an optical transmitting and receiving system and method having advantages of supporting transmission of a Single Input Single Output (SISO) signal and a MIMO signal, and supporting large-capacity transmission of an Indoor DAS based on a RoF transmission technology.

An example embodiment of the present disclosure provides an optical transmitting and receiving system including: a Main Hub Unit (MHU) configured to perform wavelength division multiplexing on a plurality of downlink signals using a plurality of wavelengths and transmit the multiplexed downlink signal through a first optical cable; a first Remote Optical Unit (ROU) configured to perform demultiplexing on the multiplexed downlink signal received from the MHU and output a part of the plurality of downlink signals; and a second ROU configured to perform demultiplexing on the multiplexed downlink signal and output other part of the plurality of downlink signals.

According to an embodiment of the present disclosure, the first ROU may perform wavelength division multiplexing on a plurality of uplink signals and transmit the multiplexed uplink signal to the MHU through the first optical cable.

According to an embodiment of the present disclosure, the first ROU may transmit the multiplexed downlink signal to the second ROU through a second optical cable.

According to an embodiment of the present disclosure, the second ROU may perform wavelength division multiplexing on a plurality of uplink signals and transmit the multiplexed uplink signal to the MHU through the first optical cable and the second optical cable.

According to an embodiment of the present disclosure, the second ROU may transmit the multiplexed uplink signal to the first ROU through the second optical cable.

According to an embodiment of the present disclosure, the method may further include an Optical Distribution Unit (ODU) connected to the MHU through the first optical cable, and the MHU may transmit the multiplexed downlink signal to the first ROU through the first optical cable and a second optical cable between the ODU and the first ROU.

According to an embodiment of the present disclosure, the first ROU may perform wavelength division multiplexing on a plurality of uplink signals and transmit the multiplexed uplink signal to the MHU through the first optical cable and the second optical cable.

According to an embodiment of the present disclosure, the MHU may transmit the multiplexed downlink signal to the first ROU through the first optical cable and a third optical cable connected between the ODU and the second ROU.

According to an embodiment of the present disclosure, the second ROU may perform wavelength division multiplexing on a plurality of uplink signals and transmit the multiplexed uplink signal to the MHU through the first optical cable and the third optical cable.

According to an embodiment of the present disclosure, the MHU may perform 4×4 MIMO transmission, and each of the first ROU and the second ROU may perform 2×2 MIMO transmission.

Another embodiment of the present disclosure provides an optical transmitting and receiving system including: a first MHU configured to perform wavelength division multiplexing on a first downlink signal to a fourth downlink signal and transmit the multiplexed downlink signal; a first ROU configured to perform demultiplexing on the multiplexed downlink signal received from the first MHU to output the first downlink signal and the second downlink signal, and transmit the multiplexed downlink signal; and a second ROU configured to perform demultiplexing on the multiplexed downlink signal received from the first ROU to output the third downlink signal and the fourth downlink signal.

According to an embodiment of the present disclosure, the first ROU may perform wavelength division multiplexing on a first uplink signal and a second uplink signal and transmit the multiplexed uplink signal to the first MHU.

According to an embodiment of the present disclosure, the second ROU may perform wavelength division multiplexing on a third uplink signal and a fourth uplink signal and transmit the multiplexed uplink signal to the first MHU through the first ROU.

According to an embodiment of the present disclosure, the method may further include a second MHU configured to perform wavelength division multiplexing on a fifth downlink signal to an eighth downlink signal and transmit the multiplexed downlink signal; a third ROU configured to perform demultiplexing on the multiplexed downlink signal received from the second MHU to output the fifth downlink signal and the sixth downlink signal, and transmit the multiplexed downlink signal; and a fourth ROU configured to perform demultiplexing on the multiplexed downlink signal received from the third ROU to output the seventh downlink signal and the eighth downlink signal.

According to an embodiment of the present disclosure, the third ROU may perform wavelength division multiplexing on a fifth uplink signal and a sixth uplink signal and transmit the multiplexed uplink signal to the second MHU, and the fourth ROU may perform wavelength division multiplexing on a seventh uplink signal and an eighth uplink signal and transmit the multiplexed uplink signal to the second MHU through the third ROU.

Yet another embodiment of the present disclosure provides an optical transmitting and receiving system including: a first MHU configured to perform wavelength division multiplexing on a first downlink signal to a fourth downlink signal and transmit the multiplexed downlink signal to an ODU; a first ROU configured to perform demultiplexing on the multiplexed downlink signal received from the ODU to output the first downlink signal and the second downlink signal; and a second ROU configured to perform demultiplexing on the multiplexed downlink signal received from the ODU to output the third downlink signal and the fourth downlink signal.

According to an embodiment of the present disclosure, the first ROU may perform wavelength division multiplexing on a first uplink signal and a second uplink signal and transmit the multiplexed uplink signal to the first MHU through the ODU.

According to an embodiment of the present disclosure, the second ROU may perform wavelength division multiplexing on a third uplink signal and a fourth uplink signal and transmit the multiplexed uplink signal to the first MHU through the ODU.

According to an embodiment of the present disclosure, the method may further include a second MHU configured to perform wavelength division multiplexing on a fifth downlink signal to an eighth downlink signal and transmit the multiplexed downlink signal to the ODU; a third ROU configured to perform demultiplexing on the multiplexed downlink signal received from the ODU to output the fifth downlink signal and the sixth downlink signal; and a fourth ROU configured to perform demultiplexing on the multiplexed downlink signal received from the ODU to output the seventh downlink signal and the eighth downlink signal.

According to an embodiment of the present disclosure, the third ROU may perform wavelength division multiplexing on a fifth uplink signal and a sixth uplink signal and transmit the multiplexed uplink signal to the second MHU through the ODU, and the fourth ROU may perform wavelength division multiplexing on a seventh uplink signal and an eighth uplink signal and transmit the multiplexed uplink signal to the second MHU through the ODU.

### BRIEF DESCRIPTION OF THE DRAWINGS

FIG. 1 is a block diagram illustrating an analog RoF transmission system according to an embodiment of the present disclosure.

FIG. 2 is a conceptual diagram illustrating an optical transmitting and receiving system according to an embodiment of the present disclosure.

FIG. 3 is a block diagram illustrating an optical transmitting and receiving system according to an embodiment of the present disclosure.

FIG. 4 is a block diagram illustrating an optical transmitting and receiving system according to an embodiment of the present disclosure.

FIG. 5 is a block diagram illustrating an optical transmitting and receiving system according to an embodiment of the present disclosure.

FIG. 6 is a block diagram illustrating an optical transmitting and receiving system according to an embodiment of the present disclosure.

FIG. 7 is a flowchart illustrating an optical transmitting and receiving method according to an embodiment of the present disclosure.

FIG. 8 is a flowchart illustrating an optical transmitting and receiving method according to an embodiment of the present disclosure.

FIG. 9 is a block diagram illustrating a computing device for implementing an optical transmitting and receiving system and method according to an embodiment of the present disclosure.

### DETAILED DESCRIPTION OF THE EMBODIMENTS

Hereinafter, embodiments of the present disclosure will be described in detail with reference to the accompanying drawings so that those of ordinary skill in the art may easily implement the present disclosure. However, the present disclosure may be implemented in various different ways and is not limited to the embodiments described herein.

In the drawings, parts irrelevant to the description are omitted in order to clearly describe the present disclosure, and like reference numerals are assigned to like elements throughout the specification.

Throughout the specification and claims, unless explicitly described to the contrary, the word “comprise”, and variations such as “comprises” or “comprising”, will be understood to imply the inclusion of stated elements but not the exclusion of any other elements. In addition, terms such as “ . . . unit”, “ . . . group”, and “module” described in the specification mean a unit that processes at least one function or operation, and it can be implemented as hardware or software or a combination of hardware and software.

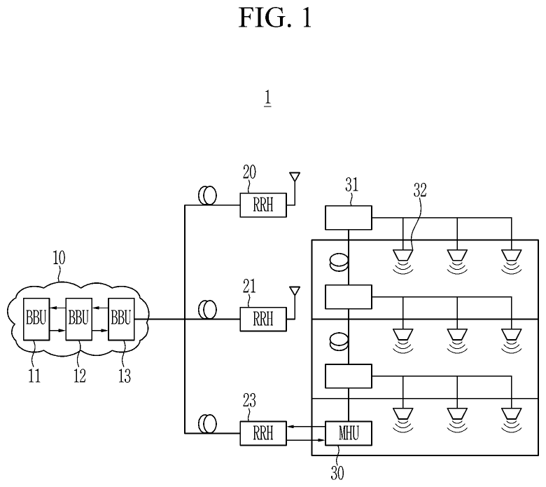

FIG. 1 is a block diagram illustrating an analog RoF transmission system according to an embodiment of the present disclosure.

Referring to FIG. 1, a RoF transmission system 1 according to an embodiment of the present disclosure may separate Remote Radio Heads (RRHs) 20, 21, and 23 from digital devices of a base station such as Base-Band Units (BBUs) 11, 12, and 13, and centrally process BBU pool 10 including BBUs 11, 12, and 13 while distribute RRHs 20, 21, and 23 to the service area. Accordingly, the RoF transmission system 1 may be implemented as a Cloud Radio Access Network (C-RAN), but the scope of the present disclosure is not limited thereto. Meanwhile, in some embodiments of the present disclosure, the BBU may correspond to a Digital Unit (DU) of the base station, and the RRH may correspond to a Radio Unit (RU).

The RoF transmission system 1 may transmit or receive signals in a mobile fronthaul. In this embodiment, the mobile fronthaul may refer to a network connecting BBU pool 10 or at least one of the BBUs 11, 12, and 13, and the RRHs 20 and 21.

Further, the RoF transmission system 1 can transmit or receive signals with an indoor distributed antenna system. In this embodiment, the indoor distributed antenna system may include a Main Hub Unit (MHU) 30, a Remote Hub Unit (RHU) 31, and a Remote Antenna Unit (RAU) 32. The MHU 30 may be connected to the RRH 23 and convert a signal received from the RRH 23 into an optical signal. The MHU 30 may transmit the converted optical signal to the RHU 31. The RHU 31 may transmit the optical signal transmitted from the MHU 30 to a plurality of RAUs 32 located indoors. In this embodiment, the RHU 31 may be connected to a maximum of 8 RAUs 32.

Here, the BBU pool 10 and the RRHs 20, 21, and 23 may be connected to each other through an analog optical link. That is, the optical transmitting and receiving system 1 may implement a mobile fronthaul or indoor distributed antenna system based on an analog RoF transmission technology. Accordingly, the optical transmitting and receiving system 1 may reduce or eliminate an increase in transmission capacity due to digital sampling by transmitting the RF signal in an analog form through an optical link without converting it to digital.

Representative examples of analog RoF transmission technologies include Radio Frequency over Fiber (RF-over-Fiber, RFoF) and Intermediate Frequency over Fiber (IF-over-Fiber, IFoF). RFoF has a carrier frequency of several GHz, and the structure of the RRH is relatively simple, but the degree of signal distortion and deterioration according to the RF frequency is high, while IFoF has a carrier frequency of several tens of MHz, and the structure of the RRH is relatively complex, but the degree of signal distortion and deterioration according to the RF frequency is low. Representative applications of RFoF include optical repeater systems (indoor distributed antenna systems) and CATV (Community Antenna Television) transmission systems, and representative applications of IFoF include mobile backhaul/fronthaul and wired/wireless convergence subscriber networks.

Meanwhile, the BBU pool 10 or the BBUs 11, 12, and 13, and the RRHs 20, 21, and 23 may be connected in various network topologies, for example, a ring type, a star type, and a bus type.

For analog RoF transmission, methods such as “CPRI over Dedicated Fiber”, “CPRI over TDM-PON (EPON/GPON)”, “CPRI over WDM (P-to-P WDM)”, and “CPRI over WDM/OTN” may be used, and these methods may be determined in consideration of the construction cost, whether bandwidth is guaranteed, whether it is suitable for short-range communication or long-distance communication, the degree of delay, and the OAM (Operations, Administration and Management) method, but the scope of the present disclosure is not limited thereto.

In addition, in analog RoF transmission, an In-phase Quadrature (IQ) data compression algorithm: for example, “Up-Down Sampling” algorithm that extracts only 2/3 samples of the whole after sampling the original signal in detail, “Non-linear Quantization” algorithm that performs sampling by focusing on information-rich data areas, “Block Scaling” algorithm that performs compression by reducing the data sampling bit level, “Partial Bit Sampling” algorithm that transmits after removing some lower bits, and replaces half with ‘1’ and the rest with ‘0’ considering Gaussian distribution in the corresponding bit when restoring, “Compressive Sensing” algorithm that performs compression at a rate less than the Nyquist sampling rate, etc. may be used in order to eliminate an increase in traffic caused by digital sampling. These algorithms may be determined in consideration of implementation cost, implementation complexity, compression quality, degree of compression loss, compression speed, and the like, but the scope of the present invention is not limited thereto.

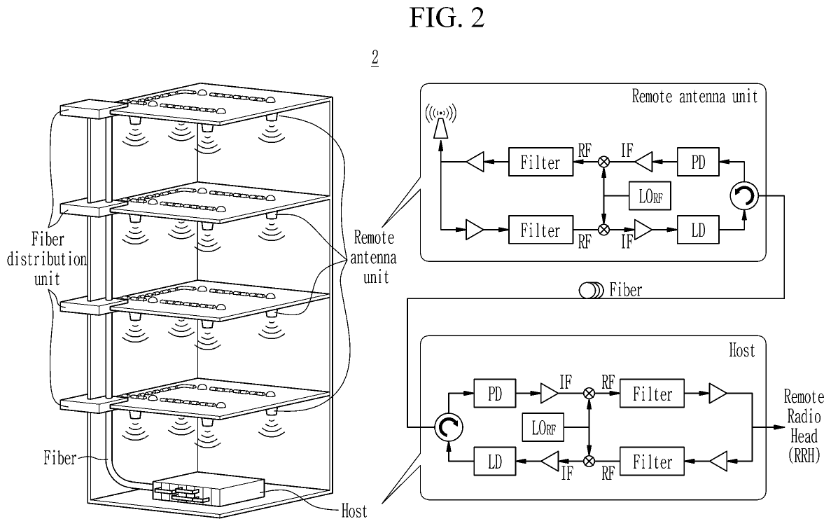

FIG. 2 is a conceptual diagram illustrating an optical transmitting and receiving system according to an embodiment of the present disclosure.

Referring to FIG. 2, an optical transmitting and receiving system 2 according to an embodiment of the present disclosure may be implemented as an indoor distributed antenna system based on an analog IFoF.

Specifically, the optical transmitting and receiving system 2 may include a host, a fiber, a fiber distribution unit, and a Remote Antenna Unit (RAU), the host may correspond to the MHU 30 of FIG. 1, and the RAU may correspond to the RAU 32 of FIG. 1.

The host, for example, may receive a downlink signal from the RRH, and transmit the downlink signal to the RAU through the fiber, and the RAU may transmit the downlink signal to devices or equipment existing indoors. Conversely, the RAU may receive uplink signals from devices or equipment existing indoors, and transmit the uplink signals to the host through the fiber, and the host, for example, may transmit the uplink signals to the RRH.

The host may be implemented to include a Photo Diode (PD), a Laser Diode (LD), an amplifier, a filter, or the like. When the host receives a downlink signal from the RRH, it may convert a Radio Frequency (RF) downlink signal into an Intermediate Frequency (IF) downlink signal, and transmit the converted IF downlink signal to the RAU through the fiber using the Laser Diode (LD). Meanwhile, when the host receives an uplink signal from the RAU through the fiber using the Photo Diode (PD), it may convert the IF uplink signal into an RF uplink signal, and transmit the converted RF uplink signal to the RRH.

RAU may also be implemented to include a Photo Diode (PD), a Laser Diode (LD), an amplifier, a filter, and the like. When RAU receives a downlink signal from the host through the fiber using a Photo Diode (PD), it may convert the IF downlink signal into an RF downlink signal, and transmit the converted RF downlink signal into devices or equipment existing indoors. Meanwhile, when RAU receives an uplink signal from devices or equipment existing indoors, it may convert an RF uplink signal into an IF uplink signal, and transmit the converted IF uplink signal to the host through the fiber using the Laser Diode (LD).

For more detailed information about the analog IFoF-based indoor distributed antenna system, since it is possible to refer to already known information, a more detailed description thereof will be omitted herein.

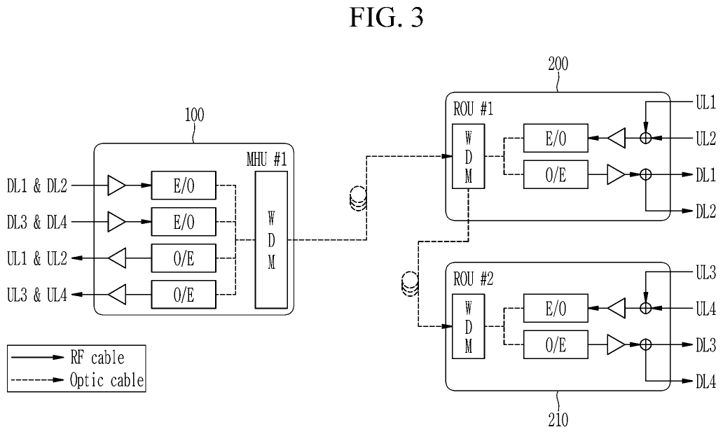

FIG. 3 is a block diagram illustrating an optical transmitting and receiving system according to an embodiment of the present disclosure.

Referring to FIG. 3, an optical transmitting and receiving system according to an embodiment of the present disclosure may include an MHU 100, a first ROU 200 and a second ROU 210.

The MHU 100 may perform wavelength division multiplexing on a plurality of downlink signals using a plurality of wavelengths, and transmit the multiplexed downlink signal through a first optical cable. Here, the first optical cable refers to an optical cable connected between the MHU 100 and the first ROU 200.

Specifically, the MHU 100 may receive a plurality of downlink signals DL1 to DL4, perform electrical to optical conversion (E/O) on the plurality of downlink signals DL1 to DL4, and perform wavelength division multiplexing (WDM) using a plurality of wavelengths. Wavelength division multiplexing may mean multiplexing signals of different wavelengths and transmitting the multiplexed signal through a single line, and demultiplexing may mean separating an optical signal transmitted through a single line into each signal. The first ROU 200 may perform demultiplexing on the multiplexed downlink signal received from the MHU 100 and output a part of the plurality of downlink signals DL1 and DL2. Meanwhile, the first ROU 200 may perform wavelength division multiplexing (WDM) on a plurality of uplink signals UL1 and UL2, and transmit the multiplexed uplink signal to the MHU 100 through the first optical cable.

The second ROU 210 may perform demultiplexing on the multiplexed downlink signal, and output other part of the plurality of downlink signals DL3 and DL4. To this end, first, the first ROU 200 may transmit a multiplexed downlink signal to the second ROU 210 through a second optical cable. Here, the second optical cable may represent an optical cable connected between the first ROU 200 and the second ROU 210. Thereafter, the second ROU 210 may perform demultiplexing on the multiplexed downlink signal received from the first ROU 200 through the second optical cable, and output other part of the plurality of downlink signals DL3 and DL4.

Meanwhile, the second ROU 210 may perform wavelength division multiplexing (WDM) on a plurality of uplink signals UL3 and UL4, and transmit the multiplexed uplink signal to the MHU 100 through the first optical cable and the second optical cable. To this end, first, the second ROU 210 may transmit a multiplexed uplink signal to the first ROU 200 through the second optical cable.

The MHU 100 may receive the multiplexed uplink signal from the first ROU 200 or the second ROU 210 through the first optical cable, perform demultiplexing and optical to electrical conversion (O/E) on the multiplexed uplink signal, and output a plurality of uplink signals UL1 and UL2, or UL3 and UL4.

As described above, according to the present embodiment, the MHU 100 may perform 4×4 MIMO transmission, and the first ROU 200 and the second ROU 210 may each perform 2×2 MIMO transmission. Accordingly, in the optical transmitting and receiving system according to an embodiment of the present disclosure, that is, the indoor distributed antenna system, 4×4 MIMO signal transmission may be implemented using one MHU 100 and two ROUs 200 and 210. In addition, since one MHU 100 is connected to two ROUs 200, 210 with one optical cable (i.e., the first optical cable) using wavelength division multiplexing technology, the number of wavelengths required for 4×4 MIMO transmission is a total of two.

In addition, since the second ROU 210 is not directly connected to the MHU 100, but is connected to the first ROU 200 in a cascade manner, when building an optical transmitting and receiving system, that is, an indoor distributed antenna system in an indoor environment with high population density, all ROUs do not need to be connected to the MHU, so that the number of required optical cables can be minimized, and the configuration is simple, which has the advantage of reducing the initial construction cost.

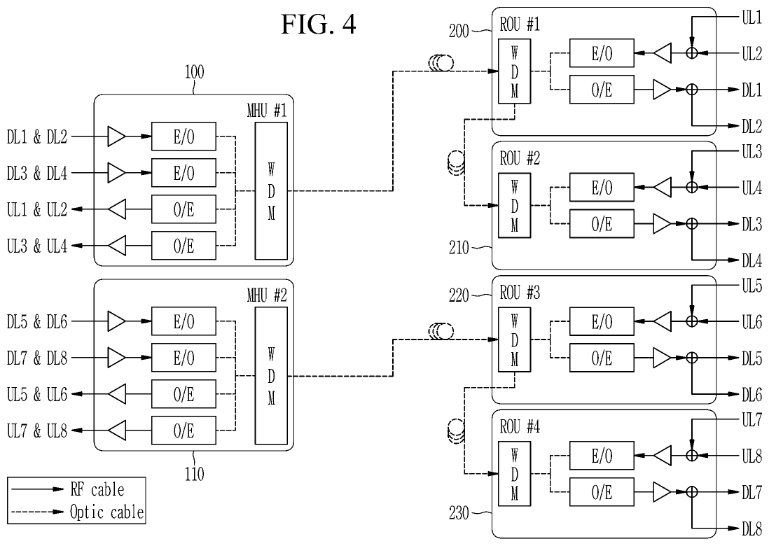

FIG. 4 is a block diagram illustrating an optical transmitting and receiving system according to an embodiment of the present disclosure.

Referring to FIG. 4, an optical transmitting and receiving system according to an embodiment of the present disclosure may include a first MHU 100, a second MHU 110, a first ROU 200, a second ROU 210, a third ROU 220, and a fourth ROU 230.

For the first MHU 100, the first ROU 200, and the second ROU 210, the description of the MHU 100, the first ROU 200, and the second ROU 210 of FIG. 3 may be referred to, therefore, redundant descriptions will be omitted here.

The second MHU 110 may perform wavelength division multiplexing on a plurality of downlink signals using a plurality of wavelengths, and transmit the multiplexed downlink signal through a third optical cable. Here, the third optical cable refers to an optical cable connected between the second MHU 110 and the third ROU 220.

Specifically, the second MHU 100 may receive a plurality of downlink signals DL5 to DL8, perform electrical optical conversion (E/O) on the plurality of downlink signals DL5 to DL8, and perform wavelength division multiplexing (WDM) using a plurality of wavelengths.

The third ROU 220 may perform demultiplexing on the multiplexed downlink signal received from the second MHU 110 and output a part of the plurality of downlink signals DL5 and DL6. Meanwhile, the third ROU 220 may perform wavelength division multiplexing (WDM) on a plurality of uplink signals UL5 and UL6, and transmit the multiplexed uplink signal to the second MHU 110 through a third optical cable.

The fourth ROU 230 may perform demultiplexing on the multiplexed downlink signal, and output other part of the plurality of downlink signals DL7 and DL8. To this end, first, the third ROU 220 may transmit a multiplexed downlink signal to the fourth ROU 230 through a fourth optical cable. Here, the fourth optical cable may represent an optical cable connected between the third ROU 220 and the fourth ROU 230. Thereafter, the fourth ROU 230 performs demultiplexing on the multiplexed downlink signal received from the third ROU 220 through the fourth optical cable, and output other part of the plurality of downlink signals DL7 and DL8.

Meanwhile, the fourth ROU 230 may perform wavelength division multiplexing (WDM) on a plurality of uplink signals UL7 and UL8, and transmit the multiplexed uplink signal to the second MHU 110 through the third optical cable and the fourth optical cable. To this end, first, the fourth ROU 230 may transmit a multiplexed uplink signal to the third ROU 220 through the fourth optical cable.

The second MHU 110 may receive the multiplexed uplink signal from the third ROU 220 or the fourth ROU 230 through the third optical cable, perform demultiplexing and optical to electrical conversion (0/E) on the multiplexed uplink signal, and output a plurality of uplink signals UL5 and UL6, or UL7 and UL8.

As described above, according to the present embodiment, the first MHU 100 may perform 4×4 MIMO transmission, and the first ROU 200 and the second ROU 210 may each perform 2×2 MIMO transmission. In addition, the second MHU 110 may perform 4×4 MIMO transmission, and the third ROU 220 and the fourth ROU 230 may each perform 2×2 MIMO transmission. Accordingly, in an optical transmitting and receiving system according to an embodiment of the present disclosure, that is, an indoor distributed antenna system, 8×8 MIMO signal transmission may be implemented using two MHUs 100 and 110 and four ROUs 200, 210, 220, and 230. In addition, since one MHU 100 or 110 is connected to two ROUs 200 and 210, or 220 and 230 with one optical cable (i.e., the first optical cable or the third optical cable) using wavelength division multiplexing technology, the number of wavelengths required for 8×8 MIMO transmission is a total of four.

In addition, since the ROU 210, 230 is not directly connected to the MHU 100, 110, but is connected to the ROU 200, 220 in a cascade manner, when building an optical transmitting and receiving system, that is, an indoor distributed antenna system in an indoor environment with high population density, all ROUs do not need to be connected to the MHU, so that the number of required optical cables can be minimized, and the configuration is simple, which has the advantage of reducing the initial construction cost.

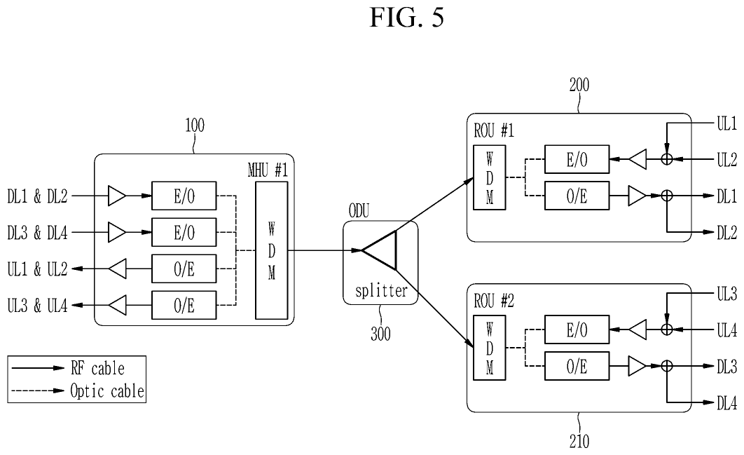

FIG. 5 is a block diagram illustrating an optical transmitting and receiving system according to an embodiment of the present disclosure.

Referring to FIG. 5, an optical transmitting and receiving system according to an embodiment of the present disclosure may include an MHU 100, a first ROU 200, a second ROU 210, and an ODU 300. Here, the ODU 300 may be connected to the MHU 100 by a first optical cable, may be connected to the first ROU 200 by a second optical cable, and may be connected to the second ROU 210 by a third optical cable.

MHU 100 may transmit the downlink signal which is generated by performing wavelength division multiplexing (WDM) on a plurality of downlink signals DL1 to DL4 using a plurality of wavelengths to the first ROU 200 through the first optical cable and the second optical cable.

The first ROU 200 may perform demultiplexing on the multiplexed downlink signal received from the MHU 100 and output a part of the plurality of downlink signals DL1 and DL2. Meanwhile, the first ROU 200 may perform wavelength division multiplexing (WDM) on a plurality of uplink signals UL1 and UL2, and transmit the multiplexed uplink signal to the MHU 100 through the first optical cable and the second optical cable.

On the other hand, the MHU 100 may transmit the downlink signal which is generated by performing wavelength division multiplexing (WDM) on a plurality of downlink signals DL1 to DL4 using a plurality of wavelengths to the second ROU 210 through the first optical cable and the third optical cable.

The second ROU 210 may perform demultiplexing on the multiplexed downlink signal received from the MHU 100 and output a part of the plurality of downlink signals DL3 and DL4. Meanwhile, the second ROU 210 may perform wavelength division multiplexing (WDM) on a plurality of uplink signals UL3 and UL4, and transmit the multiplexed uplink signal to the MHU 100 through the first optical cable and the third optical cable.

The MHU 100 may receive the multiplexed uplink signal from the first ROU 200 or the second ROU 210 through the first optical cable, perform demultiplexing and optical to electrical conversion (O/E) on the multiplexed uplink signal, and output a plurality of uplink signals UL1 and UL2, or UL3 and UL4.

As described above, according to the present embodiment, unlike a method in which the ROU is connected to the MHU in a cascade manner, each of the ROUs 200 and 210 is optically connected to the ODU 300. In a medium/large-scale indoor environment such as a building, rather than a small space such as an office, the ODU 300 may be disposed between floors, so that it may be easy to construct an indoor distributed antenna system.

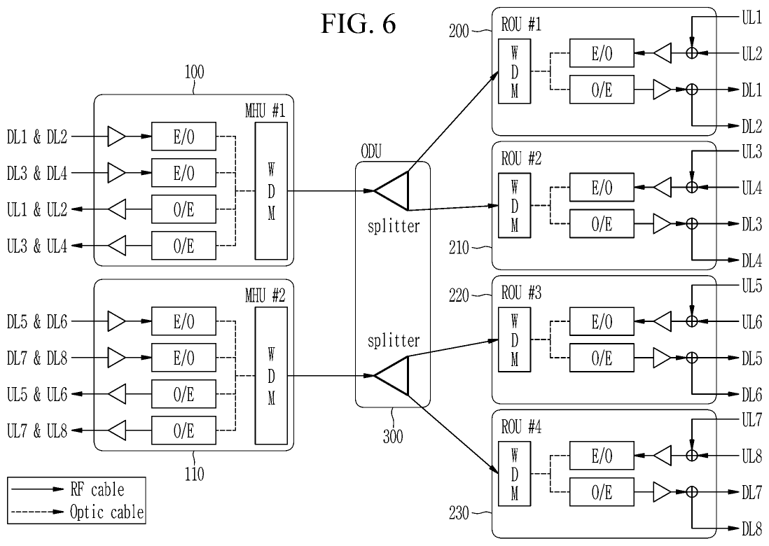

FIG. 6 is a block diagram illustrating an optical transmitting and receiving system according to an embodiment of the present disclosure.

Referring to FIG. 6, an optical transmitting and receiving system according to an embodiment of the present disclosure may include a first MHU 100, a second MHU 110, a first ROU 200, a second ROU 210, a third ROU 220, a fourth ROU (230) and an ODU (300).

For the first MHU 100, the first ROU 200, and the second ROU 210, the description of the MHU 100, the first ROU 200, and the second ROU 210 of FIG. 5 may be referred to, therefore, redundant descriptions will be omitted here.

The ODU 300 may be connected to the second MHU 110 by a fourth optical cable, may be connected to the third ROU 220 by a fifth optical cable, and may be connected to the fourth ROU 230 by a sixth optical cable.

The second MHU 110 may transmit the downlink signal which is generated by performing wavelength division multiplexing (WDM) on a plurality of downlink signals DL5 to DL8 using a plurality of wavelengths to the third ROU 220 through the fourth optical cable and the fifth optical cable.

The third ROU 220 may perform demultiplexing on the multiplexed downlink signal received from the second MHU 110 and output a part of the plurality of downlink signals DL5 and DL6. Meanwhile, the third ROU 220 may perform wavelength division multiplexing (WDM) on a plurality of uplink signals UL5 and UL6, and transmit the multiplexed uplink signal to the second MHU 110 through the fourth optical cable and the fifth optical cable.

On the other hand, the second MHU 110 may transmit the downlink signal which is generated by performing wavelength division multiplexing (WDM) on a plurality of downlink signals DL5 to DL8 using a plurality of wavelengths to the fourth ROU 230 through the fourth optical cable and the sixth optical cable.

The fourth ROU 230 may perform demultiplexing on the multiplexed downlink signal received from the second MHU 110 and output a part of the plurality of downlink signals DL7 and DL8. Meanwhile, the fourth ROU 230 may perform wavelength division multiplexing (WDM) on a plurality of uplink signals UL7 and UL8, and transmit the multiplexed uplink signal to the second MHU 110 through the fourth optical cable and the sixth optical cable.

The second MHU 110 may receive the multiplexed uplink signal from the third ROU 220 or the fourth ROU 230 through the fourth optical cable, perform demultiplexing and optical to electrical conversion (O/E) on the multiplexed uplink signal, and output a plurality of uplink signals UL5 and UL6, or UL7 and UL8.

As described above, according to the present embodiment, the number of connected ROUs can be expanded by increasing the number of branches of the ODU 300. For example, in an indoor environment of a large space with high population density, with 1 or 2 ROUs, there is a limit to transmitting a wireless signal without a shaded area. Therefore, by increasing the number of branches of the ODU to expand the number of ROUs, there is an advantage of being able to cover a wide indoor environment without a shade area.

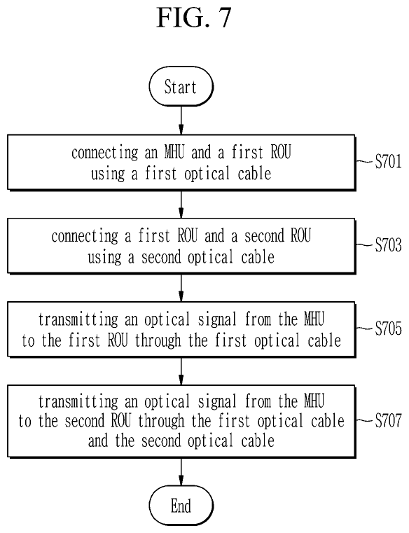

FIG. 7 is a flowchart illustrating an optical transmitting and receiving method according to an embodiment of the present disclosure.

Referring to FIG. 7, an optical transmitting and receiving method according to an embodiment of the present disclosure may include: connecting an MHU and a first ROU using a first optical cable (S701), connecting a first ROU and a second ROU using a second optical cable (S703), transmitting an optical signal from the MHU to the first ROU through the first optical cable (S705), and transmitting an optical signal from the MHU to the second ROU through the first optical cable and the second optical cable (S707).

For more detailed information on the optical transmitting and receiving method according to the present embodiment, reference may be made to the contents described above with respect to FIG. 1 to FIG. 4.

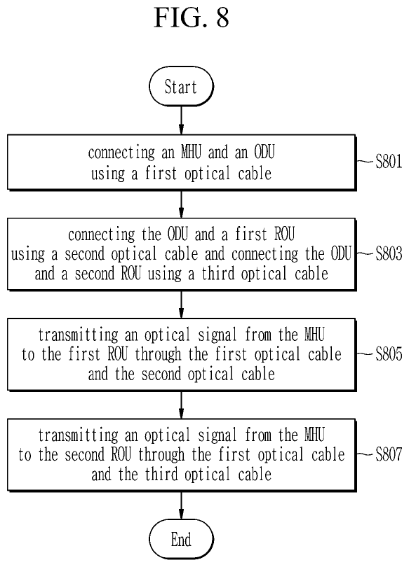

FIG. 8 is a flowchart illustrating an optical transmitting and receiving method according to an embodiment of the present disclosure.

Referring to FIG. 8, an optical transmitting and receiving method according to an embodiment of the present disclosure may include: connecting an MHU and an ODU using a first optical cable (S801), connecting the ODU and a first ROU using a second optical cable and connecting the ODU and a second ROU using a third optical cable (S803), transmitting an optical signal from the MHU to the first ROU through the first optical cable and the second optical cable (S805), and transmitting an optical signal from the MHU to the second ROU through the first optical cable and the third optical cable (S807).

For more detailed information on the optical transmitting and receiving method according to the present embodiment, reference may be made to the contents described above with respect to FIG. 1 to FIG. 2 and FIG. 6 to FIG. 7.

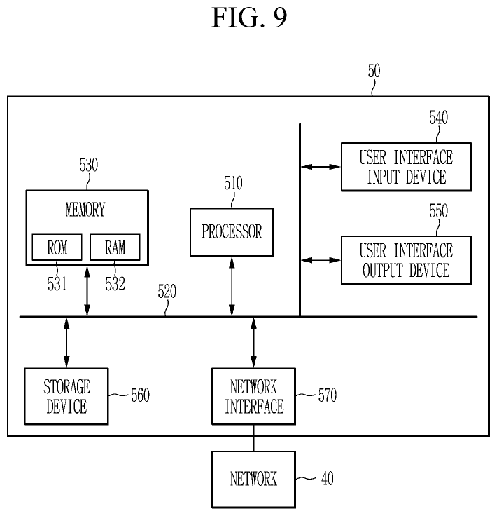

FIG. 9 is a block diagram illustrating a computing device for implementing an optical transmitting and receiving system and method according to an embodiment of the present disclosure.

Referring to FIG. 9, an optical transmitting and receiving system and method according to an embodiment of the present disclosure may be implemented using a computing device 50.

The computing device 50 includes at least one of a processor 510, a memory 530, a user interface input device 540, a user interface output device 550, and a storage device 560 communicating through a bus 520. The computing device 50 may also include a network 40, such as a network interface 570 that is electrically connected to a wireless network. The network interface 570 may transmit or receive signals with other entities through the network 40.

The processor 510 may be implemented in various types such as an application processor (AP), a central processing unit (CPU), and a graphic processing unit (GPU), and may be any semiconductor device which executes instructions stored in the memory 530 or the storage device 560. The processor 510 may be configured to implement the functions and methods described in FIG. 1 to FIG. 8.

The memory 530 and the storage device 560 may include various types of volatile or nonvolatile storage media. For example, the memory may include read-only memory (ROM) 531 and random access memory (RAM) 532. In an embodiment of the present disclosure, the memory 530 may be located inside or outside the processor 510, and the memory 530 may be connected to the processor 510 through various known means.

In addition, at least some of an optical transmitting and receiving system and method according to embodiments of the present disclosure may be implemented as a program or software executed on the computing device 50, and the program or software may be stored in a computer-readable medium.

In addition, at least some of an optical transmitting and receiving system and method according to embodiments of the present disclosure may be implemented with hardware that can be electrically connected to the computing device 50.

According to the embodiments of the present disclosure described so far, by arranging the MHU and the ROU in a stacked structure, it is possible to implement an economical distributed antenna system capable of transmitting SISO to maximum 8×8 MIMO signals in a simple manner.

In addition, the optical transmitting and receiving system according to the embodiments of the present disclosure has low implementation complexity and supports 8×8 MIMO signal transmission, so that indoor wireless coverage can be easily expanded, and, since a low-cost low-bandwidth analog optical transceiver can be used instead of a high-bandwidth digital optical transceiver, it is possible to construct a distributed antenna system capable of large-capacity mobile transmission and economical.

In addition, the optical link structure of the optical transmitting and receiving system according to the embodiments of the present disclosure is suitable for use in both small-scale and large-scale indoor environments.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. An optical transmitting and receiving system comprising:
a Main Hub Unit (MHU) configured to perform wavelength division multiplexing on a plurality of downlink signals using a plurality of wavelengths and transmit the multiplexed downlink signal through a first optical cable;
a first Remote Optical Unit (ROU) configured to perform demultiplexing on the multiplexed downlink signal received from the MHU and output a part of the plurality of downlink signals; and
a second ROU configured to perform demultiplexing on the multiplexed downlink signal and output other part of the plurality of downlink signals.

2. The system of claim 1, wherein:
the first ROU performs wavelength division multiplexing on a plurality of uplink signals and transmits the multiplexed uplink signal to the MHU through the first optical cable.

3. The system of claim 1, wherein:
the first ROU transmits the multiplexed downlink signal to the second ROU through a second optical cable.

4. The system of claim 3, wherein:
the second ROU performs wavelength division multiplexing on a plurality of uplink signals and transmits the multiplexed uplink signal to the MHU through the first optical cable and the second optical cable.

5. The system of claim 4, wherein:
the second ROU transmits the multiplexed uplink signal to the first ROU through the second optical cable.

6. The system of claim 1, further comprising:
an Optical Distribution Unit (ODU) connected to the MHU through the first optical cable,
wherein the MHU transmits the multiplexed downlink signal to the first ROU through the first optical cable and a second optical cable between the ODU and the first ROU.

7. The system of claim 6, wherein:
the first ROU performs wavelength division multiplexing on a plurality of uplink signals and transmits the multiplexed uplink signal to the MHU through the first optical cable and the second optical cable.

8. The system of claim 6, wherein:
the MHU transmits the multiplexed downlink signal to the first ROU through the first optical cable and a third optical cable connected between the ODU and the second ROU.

9. The system of claim 8, wherein:
the second ROU performs wavelength division multiplexing on a plurality of uplink signals and transmits the multiplexed uplink signal to the MHU through the first optical cable and the third optical cable.

10. The system of claim 1, wherein:
the MHU performs 4×4 Multiple Input Multiple Output (MIMO) transmission, and each of the first ROU and the second ROU performs 2×2 MIMO transmission.

11. An optical transmitting and receiving system comprising:
a first MHU configured to perform wavelength division multiplexing on a first downlink signal to a fourth downlink signal and transmit the multiplexed downlink signal;
a first ROU configured to perform demultiplexing on the multiplexed downlink signal received from the first MHU to output the first downlink signal and the second downlink signal, and transmit the multiplexed downlink signal; and
a second ROU configured to perform demultiplexing on the multiplexed downlink signal received from the first ROU to output the third downlink signal and the fourth downlink signal.

12. The system of claim 11, wherein:
the first ROU performs wavelength division multiplexing on a first uplink signal and a second uplink signal and transmits the multiplexed uplink signal to the first MHU.

13. The system of claim 12, wherein:
the second ROU performs wavelength division multiplexing on a third uplink signal and a fourth uplink signal and transmits the multiplexed uplink signal to the first MHU through the first ROU.

14. The system of claim 11, further comprising:
a second MHU configured to perform wavelength division multiplexing on a fifth downlink signal to an eighth downlink signal and transmit the multiplexed downlink signal;
a third ROU configured to perform demultiplexing on the multiplexed downlink signal received from the second MHU to output the fifth downlink signal and the sixth downlink signal, and transmit the multiplexed downlink signal; and
a fourth ROU configured to perform demultiplexing on the multiplexed downlink signal received from the third ROU to output the seventh downlink signal and the eighth downlink signal.

15. The system of claim 14, wherein:
the third ROU performs wavelength division multiplexing on a fifth uplink signal and a sixth uplink signal and transmits the multiplexed uplink signal to the second MHU, and
the fourth ROU performs wavelength division multiplexing on a seventh uplink signal and an eighth uplink signal and transmits the multiplexed uplink signal to the second MHU through the third ROU.

16. An optical transmitting and receiving system comprising:
a first MHU configured to perform wavelength division multiplexing on a first downlink signal to a fourth downlink signal and transmit the multiplexed downlink signal to an ODU;
a first ROU configured to perform demultiplexing on the multiplexed downlink signal received from the ODU to output the first downlink signal and the second downlink signal; and
a second ROU configured to perform demultiplexing on the multiplexed downlink signal received from the ODU to output the third downlink signal and the fourth downlink signal.

17. The system of claim 16, wherein:
the first ROU performs wavelength division multiplexing on a first uplink signal and a second uplink signal and transmits the multiplexed uplink signal to the first MHU through the ODU.

18. The system of claim 17, wherein:
the second ROU performs wavelength division multiplexing on a third uplink signal and a fourth uplink signal and transmits the multiplexed uplink signal to the first MHU through the ODU.

19. The system of claim 17, further comprising:
a second MHU configured to perform wavelength division multiplexing on a fifth downlink signal to an eighth downlink signal and transmit the multiplexed downlink signal to the ODU;
a third ROU configured to perform demultiplexing on the multiplexed downlink signal received from the ODU to output the fifth downlink signal and the sixth downlink signal; and
a fourth ROU configured to perform demultiplexing on the multiplexed downlink signal received from the ODU to output the seventh downlink signal and the eighth downlink signal.

20. The system of claim 19, wherein:
the third ROU performs wavelength division multiplexing on a fifth uplink signal and a sixth uplink signal and transmits the multiplexed uplink signal to the second MHU through the ODU, and
the fourth ROU performs wavelength division multiplexing on a seventh uplink signal and an eighth uplink signal and transmits the multiplexed uplink signal to the second MHU through the ODU.
